(19) United States
(12) Patent Application Publication
(10) Pub. No.: US 2009/0174543 A1
(43) Pub. Date: Jul. 9, 2009

(54) EMERGENCY CALL APPARATUS

(76) Inventor: Tsung-Hsiang Lin, Kaohsiung Hsien (TW)

Correspondence Address: SCHMEISER, OLSEN & WATTS, 22 CENTURY HILL DRIVE, SUITE 302, LATHAM, NY, 12110, US

(21) Appl. No.: 11/970,544

(22) Filed: Jan. 8, 2008

(51) Int. Cl. G08B 23/00

(52) U.S. Cl. 340/501

(57) ABSTRACT

An emergency call apparatus includes a databank having a plurality of contact person information units; an alarm sending mechanism including a plurality of alarm generating units and an alarm output unit connected to the alarm generating units for outputting an alarm signal; an identifying mechanism linked to the databank and the alarm sending mechanism for analyzing the output alarm signal and identifying one or more contact person information units in the databank that correspond to the alarm signal; and a message transmitting mechanism linked to the identifying mechanism for cooperatively transmitting a warning message to receiving devices being used by all contact persons that are set in the corresponding contact person information units. Therefore, emergency help may be timely and widely provided to the user sending the alarm signal.

### FIELD OF THE INVENTION

The present invention relates to an emergency call apparatus, and more particularly to an emergency call apparatus that enables a user's alarm signal to be transmitted to all related contact persons set in a databank for the user to receive timely and wide emergency help.

### BACKGROUND OF THE INVENTION

As one of the results of the aging society, there are more and more aged people who live alone. Therefore, the emergency calls from aged people for medical care, home nursing, and home security have become the problems that must be faced in the aging society. As a matter of fact, these problems with the aged people form a big burden to the whole country and just could not be solved simply through governmental emergency help organizations. On the other hand, through the building of an emergency call system, the children, relatives, and friends of the aged people may together form the first and most effective aid to the aged people who require urgent help in an emergency. In this manner, emergency medical help from the government could be allocated according to priority to obtain the best possible effect.

Generally, a conventional emergency call system, when being activated by an aged man by pushing a button, will send out an alarm message to related persons via an indoor phone or a cellular phone. However, the alarm message would just become meaningless if no one answers the indoor phone or the cellular phone is not on and the alarm message is not received by others in real time. Under this condition, it is very possible to miss the golden time for helping the aged man in an emergency.

There is an alternative security system available for use, the operation of which is controlled through a centralized control mechanism. With the security system, a user may inform a security person in an emergency, so that the security person may appear to check the site to ensure the user's security and safety in life, body, and property. However, such security system is expensive and therefore not widely accepted by the aged people.

### SUMMARY OF THE INVENTION

It is therefore a primary object of the present invention to provide an improved emergency call apparatus that enables a user's alarm signal to be transmitted to all related contact persons for the user to receive timely and wide emergency help.

To achieve the above and other objects, the emergency call apparatus according to the present invention includes a databank having a plurality of contact person information units; an alarm sending mechanism including a plurality of alarm generating units and an alarm output unit connected to the alarm generating units for outputting an alarm signal; an identifying mechanism linked to the databank and the alarm sending mechanism for analyzing the output alarm signal and identifying one or more contact person information units in the databank that correspond to the alarm signal; and a message transmitting mechanism linked to the identifying mechanism for cooperatively transmitting a warning message to receiving devices being used by all contact persons that are set in the identified contact person information units. Therefore, emergency help may be timely and widely provided to the user sending the alarm signal.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a conceptual view showing a basic configuration of an emergency call apparatus according to the present invention;

FIG. 2 is a block diagram of the emergency call apparatus of the present invention; and

FIG. 3 is a block diagram showing the operation of the present invention.

### DETAILED DESCRIPTION OF THE PREFERRED EMBODIMENTS

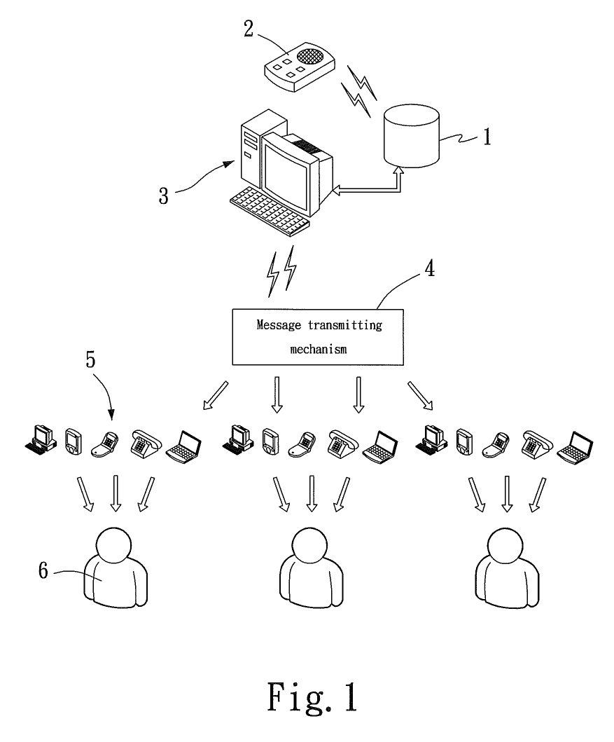

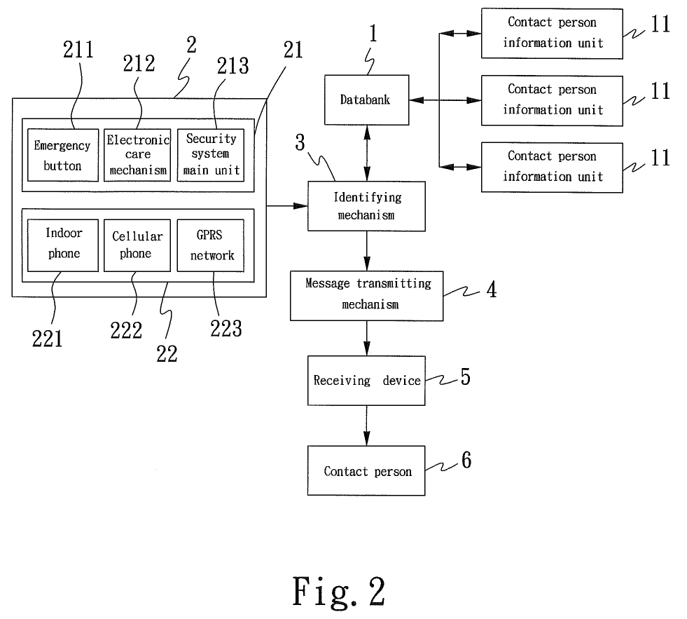

Please refer to FIG. 1 that is a conceptual view showing a basic configuration of an emergency call apparatus according to the present invention, and to FIG. 2 that is a block diagram of the emergency call apparatus of the present invention. As shown, the emergency call apparatus according to the present invention includes a databank 1, an alarm sending mechanism 2, an identifying mechanism 3, and a message transmitting mechanism 4.

The databank 1 includes a plurality of contact person information units 11, and may be a website-controllable security and broadcasting system.

The alarm sending mechanism 2 includes a plurality of alarm generating units 21 and an alarm output unit 22 connected to each of the alarm generating units 21 for outputting an alarm signal. Each of the alarm generating units 21 may include at least, for example, an emergency button 211, an electronic care mechanism 212, and a security system main unit 213. The alarm output unit 22 may include at least, for example, an indoor phone 221, a cellular phone 222, and a GPRS (General Packet Radio Service) network 223.

The identifying mechanism 3 is linked to the databank 1 and the alarm sending mechanism 2 for analyzing the alarm signal output by the alarm output unit 22 and identifying the contact person information units 11 in the databank 1 that correspond to the alarm signal.

The message transmitting mechanism 4 is linked to the identifying mechanism 3 for cooperating with the identified contact person information units 11 to transmit a warning message to receiving devices 5 being used by related contact persons 6. The message transmitting mechanism 4 may transmit at least Audio/Video (AV) message and text message.

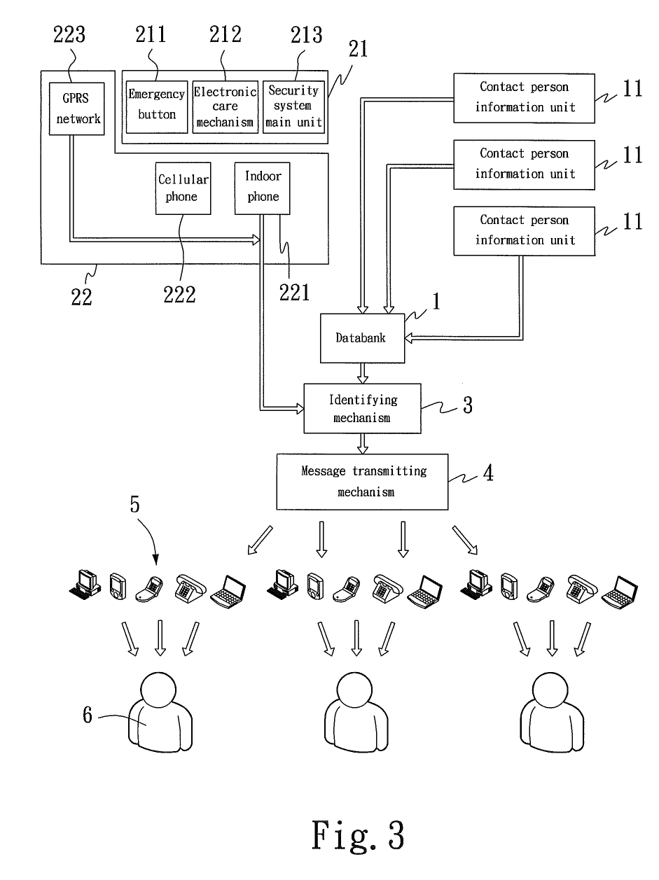

Please refer to FIG. 3 that is a block diagram showing the operation of the present invention. To use the emergency call apparatus of the present invention, a user first inputs via a network the phone numbers from which an alarm might be sent by the user, or a personal number sent by a GPRS signal, and all possible contacting means, such as web MSN, Yahoo, Skype, E-mail, cellular phone, telephone, etc., that are used by the user's children, relatives, and friends, who are to be contacted for receiving the alarm sent by the user. All these information is input to the contact person information units 11 in the databank 1.

In the event the emergency button 211 carried along with the user, who is usually an aged man, the electronic care mechanism 212, and/or the security system main unit 213 installed in the user's house send out an alarm signal, the alarm signal will be transmitted to the databank 1 (which may be a website-controllable security and broadcasting system) via the indoor phone 221, the cellular phone 222, and the GPRS network 223 of the alarm output unit 22. The identifying mechanism 3 will cooperatively analyze the phone number, the cellular phone number, and/or the GPRS personal number in and transmitted by the alarm signal, and identifies one or more of the contact person information units 11 in the databank 1 that correspond to the alarm signal. After the identification, the message transmitting mechanism 4 will broadcast or transmit a warning message, including the phone number sending the alarm signal or the user's personal location, to all the contact persons, such as the user's children, relatives, and friends as previously input to the corresponding contact person information units 11, via the previously input contact means of MSN, Yahoo, Skype, e-mail, cellular phone, telephone, etc. In this manner, it is expected at least one or two or more persons in the contact person information units 11 will immediately receive the warning message to timely and widely provide required emergency help to the user.

Since the emergency call apparatus of the present invention includes an identifying mechanism capable of identifying an alarm signal sent out by a user via an alarm sending mechanism thereof, and a message transmitting mechanism capable of transmitting a warning message to all contact persons previously set in a databank of the apparatus to thereby achieve the purpose of timely and widely providing emergency help to the user, the present invention effectively overcomes the drawbacks in the conventional similar apparatus and is more practical for use.

What is claimed is:

1. An emergency call apparatus, comprising:
a databank having a plurality of contact person information units;
an alarm sending mechanism including a plurality of alarm generating units and an alarm output unit connected to the alarm generating units for outputting an alarm signal;
an identifying mechanism being linked to the databank and the alarm sending mechanism for analyzing the alarm signal output by the alarm output unit and identifying one or more contact person information units in the databank that correspond to the alarm signal; and
a message transmitting mechanism being linked to the identifying mechanism for cooperating with the contact person information units to transmit a warning message to receiving devices being used by all contact persons that are set in the corresponding contact person information units.

2. The emergency call apparatus as claimed in claim 1, wherein each of the alarm generating units includes at least an emergency button, an electronic care mechanism, and a security system main unit.

3. The emergency call apparatus as claimed in claim 1, wherein the alarm output unit includes at least an indoor telephone, a cellular phone, and a GPRS network.

4. The emergency call apparatus as claimed in claim 1, wherein the message transmitting mechanism may transmit at least AV message and text message.
